(19) United States
(12) Patent Application Publication
(10) Pub. No.: US 2025/0297867 A1
(43) Pub. Date: Sep. 25, 2025

(54) LINE MARKING DETECTION FOR AUTONOMOUS AND SEMI-AUTONOMOUS SYSTEMS AND APPLICATIONS

(71) Applicant: NVIDIA CORPORATION, Santa Clara, CA (US)

(72) Inventors: Tian LIU, Shanghai (CN); Yu ZHANG, Sunnyvale, CA (US); Ge CONG, Pleasanton, CA (US); Yixuan LIN, San Jose, CA (US)

(21) Appl. No.: 18/667,055

(22) Filed: May 17, 2024

Related U.S. Application Data
(63) Continuation of application No. PCT/CN2024/082427, filed on Mar. 19, 2024.

(51) Int. Cl. G01C 21/00; G01S 17/89

(52) U.S. Cl. CPC G01C 21/3815; G01S 17/89

(57) ABSTRACT

In various embodiments, sensor data representing a 3D environment may be collected using one or more ego-machines while the ego-machines are navigating through the 3D environment. The sensor data may be projected into a 2D representation of the ground or other surface, and this 2D representation may form a map representing some geographic region. The map may be divided into tiles, within which detected features (e.g., road lines, road markings, surface features, etc.) may be detected and used to detect demarcated regions, such as intersections, based on the geometry and proximity of the detected features. As such, new tiles may be centered around the detected regions, and the features may be detected from each resulting centered tile. The detected features may be aggregated, de-duplicated, and/or merged, and used to label the map.

### CROSS-REFERENCE TO RELATED APPLICATIONS

This application is a continuation of International Application No. PCT/CN2024/082427 filed Mar. 19, 2024, the contents of which are hereby incorporated by reference in their entirety.

### BACKGROUND

High-definition (HD), standard definition (SD), navigational, and/or other map types serve a variety of functions in autonomous and semi-autonomous driving. For example, these detailed maps may provide a precise reference for localization, allowing autonomous or semi-autonomous vehicles to accurately determine their position in the environment by comparing real-time sensor data with the pre-existing map features. Furthermore, HD maps may contribute to path planning. For example, an autonomous vehicle may use map features such as road geometry, lane markings, and traffic signs to plan out safe and efficient trajectories. Furthermore, HD maps may offer a semantic understanding of the surroundings, encoding classifications of objects like traffic lights and stop signs and enhancing the vehicle's ability to interpret complex scenarios and make informed decisions based on contextual information. Moreover, HD maps may provide a reliable reference point in situations where sensor data might be ambiguous or incomplete. Real-time or near real-time map updates may allow autonomous vehicles to quickly adapt to changes in the environment, ensuring continuous accuracy and responsiveness to dynamic road conditions. As such, HD maps may provide autonomous and semi-autonomous driving systems with spatial awareness and facilitate safe and efficient navigation in diverse and dynamic landscapes.

Conventional techniques for generating HD maps have a variety of drawbacks. For example, conventional techniques typically generate HD maps by projecting images generated using data collection vehicle cameras onto the road surface. However, due to perspective distortion, visual features that are located far away from the camera are often depicted in the map with distortion. Furthermore, based on scene changes over time, visual features of interest are often occluded in images, which may introduce inaccuracies into the map. Some conventional techniques have sought to detect features like lane lines or boundaries from these projected images, but since visual features of interest are often depicted with distortion or occlusions, the detected features have limited accuracy. Some techniques have sought to apply semantic segmentation or line segment detection to these projected images, but this process requires substantial computational demands in post-processing, for example, to connect pieces of the same line segment from different images. As such, there is a need for improved detection and map generation techniques.

### SUMMARY

Embodiments of the present disclosure relate to navigation control line detection for autonomous and semi-autonomous systems and applications. Systems and methods are disclosed that generate a labeled (e.g., LiDAR, RADAR, ultrasonic, etc.) map with detected navigation control lines (or other road or driving surface line types) for navigation, localization, and/or other application in ego-machines.

In contrast to conventional systems, navigation control lines may be detected and labeled in a (e.g. LiDAR, RADAR, ultrasonic, image, etc.) map. Instead of or in addition to cameras, data may be collected from ego machines using one or more LiDAR sensors and/or other sensor types-such as RADAR sensors, ultrasonic sensors, etc. For example, LiDAR sensor data may be collected by one or more ego-machines, and the sensor data may be projected into a two-dimensional (2D) representation of the ground or other surface. In this example, the 2D representation of the ground may form a LiDAR map representing some geographic region that was observed by the one or more ego-machines (e.g., over time). Continuing the example, the LiDAR map may be divided into tiles, and navigation control lines (e.g., road markings, lines on the road that represent traffic signals, lines or other visual demarcations in an outdoor, indoor, or warehouse environment, etc.) may be detected from individual tiles.

In some examples, detected navigation control lines may be used to detect intersections based on the geometry and proximity of the detected navigation control lines. As such, new tiles may be centered around the detected intersections, and navigation control lines may be detected from each resulting intersection-centered tile. The detected navigation control lines from different tiles may be aggregated, de-duplicated, and/or merged, and used to label the LiDAR map. As such, the labeled LiDAR map may aid an autonomous or semi-autonomous vehicle or other ego-machine in navigating a physical environment, for example, allowing the vehicle to accurately interpret and respond to traffic signals on the road, navigate intersections safely, adhere to traffic rules, and/or assist the vehicle or machine in precisely determining its position and orientation within the road network.

### BRIEF DESCRIPTION OF THE DRAWINGS

The present systems and methods for navigation control line detection for autonomous and semi-autonomous systems and applications are described in detail below with reference to the attached drawing figures, wherein:

FIG. 1 is a data flow diagram illustrating an example map generation pipeline, in accordance with some embodiments of the present disclosure.

FIG. 2 is a diagram illustrating an example intersection detector, in accordance with some embodiments of the present disclosure;

FIG. 3 illustrates an example (e.g., LiDAR) map divided into tiles, in accordance with some embodiments of the present disclosure;

FIGS. 4A-B illustrate example detected navigation control lines, in accordance with some embodiments of the present disclosure;

FIGS. 5A-B illustrate generation of an example intersection-centered tile, in accordance with some embodiments of the present disclosure;

FIG. 6 illustrates example techniques for merging duplicates and grouping related detected navigation control lines, in accordance with some embodiments of the present disclosure;

FIG. 7 is a flow diagram illustrating a method of updating a (e.g., LiDAR) map based at least on one or more navigation control lines, in accordance with some embodiments of the present disclosure;

FIG. 8 is a flow diagram illustrating a method for detecting a refined set of navigation control lines, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed related to line, feature, and/or road/surface marking detection for autonomous and semi-autonomous systems and applications. For example, systems and methods are disclosed that project, as a non-limiting example, detected LiDAR intensity data onto a two-dimensional (2D) representation of a surface such as the ground (e.g., a LiDAR map), detect navigation control lines (e.g., traffic signal road lines) from individual tiles of the map, and label the map with detected lines and class labels. The present techniques may be used to create or update maps with navigation control lines for use by autonomous or semi-autonomous machines and other types of ego-machines.

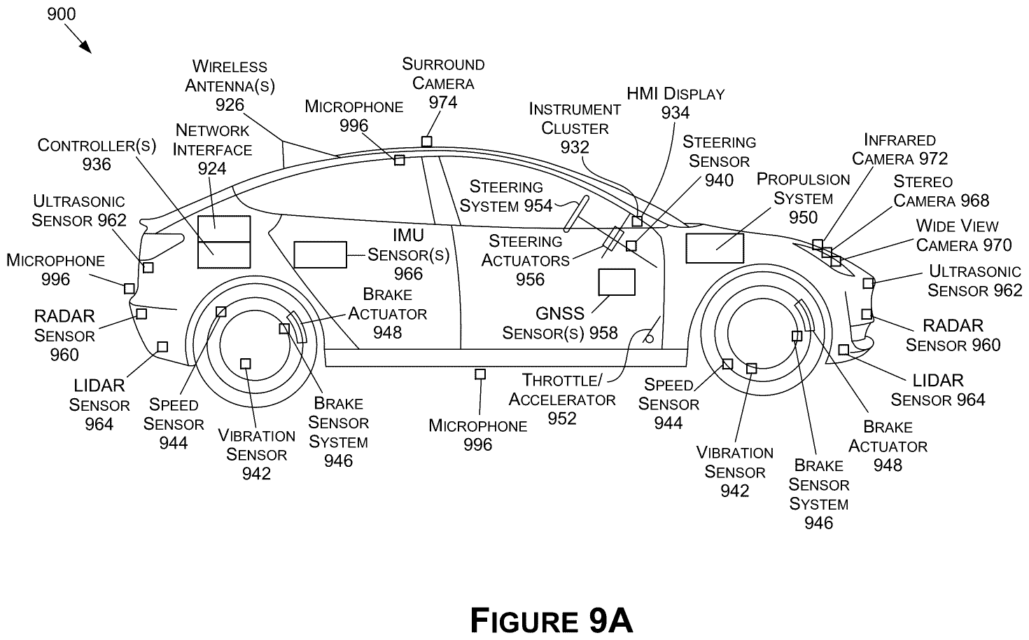

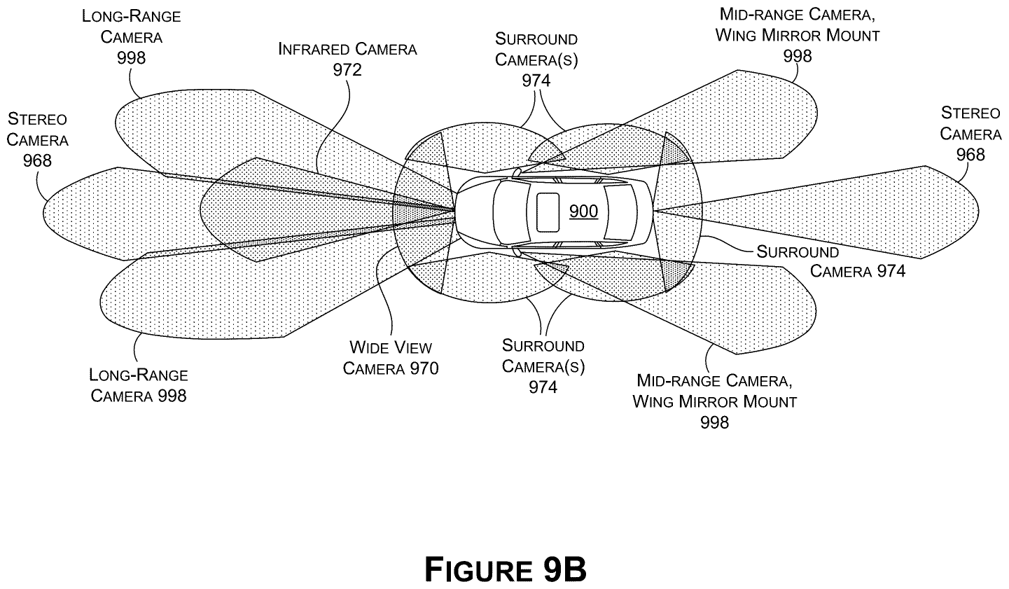

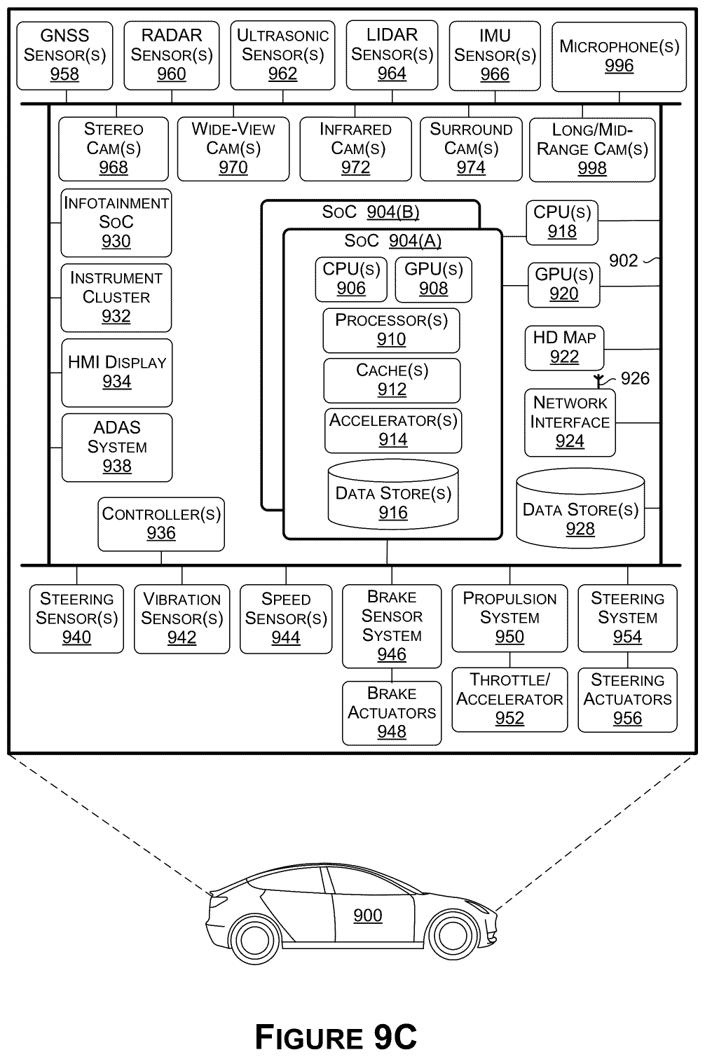

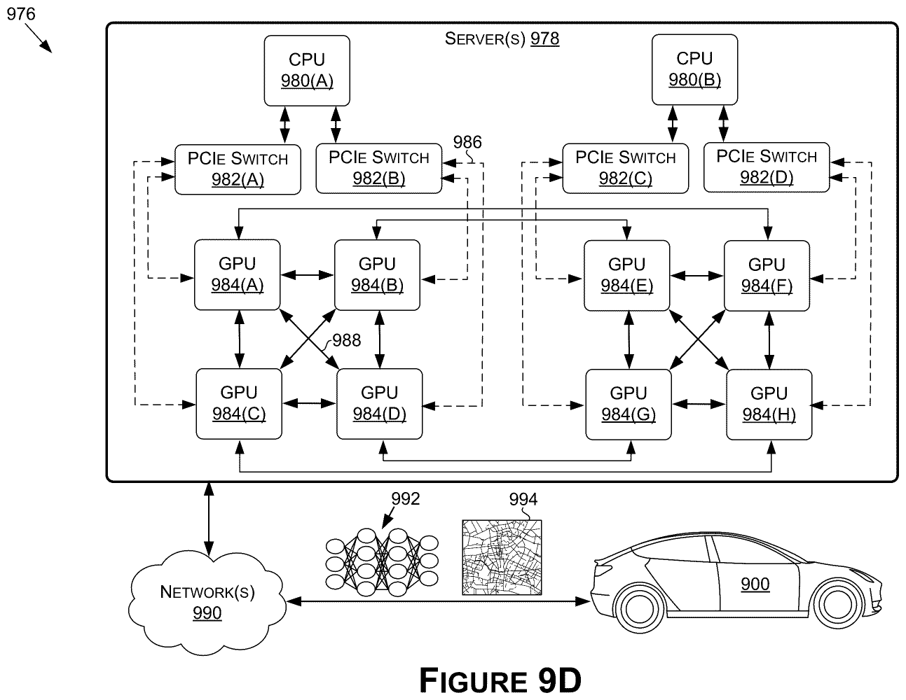

Although the present disclosure may be described with respect to an example autonomous or semi-autonomous vehicle or machine 900 (alternatively referred to herein as “vehicle 900” or “ego-machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to generating or updating maps (e.g., a LiDAR map) with detected navigation control lines for use by road vehicles, this is not intended to be limiting, and the systems and methods described herein may be used in augmented reality, virtual reality, mixed reality, robotics, security and surveillance, autonomous or semi-autonomous machine applications, and/or any other technology spaces where generating or updating maps of 2D surfaces with navigation control lines may be used.

In some embodiments, and taking an example use case in which a map supports an autonomous or semi-autonomous vehicle that navigates roads, in some embodiments, sensor (e.g., LiDAR) data may be collected using one or more ego-machines (e.g., a fleet of data collection vehicles), and the sensor data may be projected into a 2D representation of the ground or other surface. Taking an example embodiment in which the 2D representation of the ground is a LiDAR map representing some geographic region, the LiDAR map may be divided into tiles, and navigation control lines (e.g., traffic signal road lines or other road markings, lines, or features on the road that represent traffic signals, such as crosswalk lines, stop lines, or yield lines, or lines or features or other demarcations in any other environment, such as a warehouse, factory, building, park, plaza, etc.) may be detected from individual tiles and used to detect intersections based on the geometry and proximity of the detected navigation control lines. As such, new tiles may be centered around the detected intersections, and navigation control lines may be detected from each resulting intersection centered tile. The detected navigation control lines may be aggregated, de-duplicated, and/or merged, and used to label the map. As such, the labeled map may aid an autonomous vehicle in navigating a physical environment, allowing the vehicle to accurately interpret and respond to traffic signals, navigate intersections safely, adhere to traffic rules, and/or assist the vehicle in precisely determining its position and orientation within the road network, especially at intersections and traffic signal-controlled areas.

In some embodiments, LiDAR data collected from fleet vehicles may be sent to a map generation pipeline that may be used to generate a map. LiDAR data (e.g., LiDAR intensity data) collected by any number of LiDAR sensors and/or any number of vehicles may be projected onto a 2D representation of a surface (e.g., the ground) of a three-dimensional (3D) space to form projected LiDAR intensity data (e.g., a top-down projection image). This projected LiDAR intensity data may take the form of a local representation of the 2D surface (e.g., ground) in a vehicle coordinate system (e.g., a projection image) of a corresponding data collection vehicle, a list of projected data points, and/or other forms. As such, the vehicle's detected position in the 3D (or world) space may be used to aggregate the projected LiDAR intensity data into a global representation of the surface (e.g., the ground) of the 3D space (e.g., a global LiDAR map, an HD map, etc.). For example, a global LiDAR map may represent projected LiDAR data in grey scale or color and may be updated periodically based on new data (e.g., alterations to the physical road or to the navigation control lines located on the road). As such, sensor (e.g., LiDAR) data representing some geographic region may be used to construct a map of the region. Although described primarily with respect to LiDAR herein, this is not intended to be limiting, any other type or modality of sensor data may be used-such as RADAR, ultrasonic, camera, etc.

In some embodiments, to facilitate feature detection, the (e.g., global LiDAR) map may be subdivided into any suitable (e.g., fixed-size) grid cells or tiles. These tiles may either be non-overlapping or overlapping with adjacent tiles. In some embodiments, a deep neural network (DNN) (e.g., LinE segment Transformers (LETR), Tile Net V2, or any model that has the capabilities to detect lines and/or generate a list or other representation of detected polylines) may be used to detect one or more classes of navigation control lines (e.g., line segments or polylines) from each tile of the map. In an example embodiment, the output of the DNN may represent several objects, where each object encodes, represents, or otherwise identifies two points (e.g., two endpoints P1 and P2, forming a detected line segment), a classification label (e.g., a class denoting that the object does not correspond to a detected line; a supported class of a detected navigation control line, such as crosswalk lines, stop lines, yield lines; an indication that one of a plurality of supported classes was detected; etc.), and a corresponding confidence. As such, a designated threshold confidence level may be used to filter the DNN output and generate a list of detected lines and corresponding class labels. More generally, any known line detection technique may be applied to the individual tiles to detect and classify any navigation control lines present in each tile

In some embodiments, the detected navigational control lines may be clustered to infer the locations of intersections in the map. For instance, crosswalks typically have two parallel lines, and intersections may include multiple crosswalks. As such, in some embodiments, detected crosswalk lines may be searched for corresponding crosswalk segments based on distance, orientation, and/or projected overlap. In some embodiments, detected crosswalk lines may be searched for other crosswalk lines in the same intersection based on distance and/or orientation. As such, when a detected navigation control line is classified as a crosswalk line (e.g., one type of navigation control line), a corresponding crosswalk line may be searched for and grouped together with nearby crosswalk lines to form an intersection. In some embodiments, each intersection may be searched for nearby detected stop and/or yield lines, which may be clustered into the intersection. In some implementations, remaining detected stop and/or yield lines may be searched to identify the presence of other types of intersections (e.g., intersections without crosswalks, intersections other than four-way intersections) using corresponding distance and/or orientation thresholds. More generally, an intersection may be inferred from any detected navigation control line(s) that visually indicate the location of an intersection.

In some embodiments, a new intersection-centered tile may be created for each inferred intersection, navigation control line detection may be rerun on each intersection-centric tile, and the detected navigation control lines from different tiles may be aggregated, de-duplicated, and used to label or otherwise associate with the (e.g., global LiDAR) map. In some embodiments, to facilitate feature detection within an intersection-centric tile, the intersection-centric tile may be rotated (e.g., either clockwise or counterclockwise) to align more closely with the boundaries of an intersection and maximize or increase the number of intersection features that are represented within the intersection-centric tile. In some embodiments, if the intersection is larger or smaller than the resolution of an intersection-centric tile, the intersection-centric tile may be resized (e.g., applying some scaling factor such as 0.8 to 1.2). Additionally or alternatively, if an intersection is (e.g., substantially) larger than the resolution of an intersection-centric tile (e.g., a representation of an intersection containing 1500 pixels compared to an intersection-centric tile with a 1000 pixel limit), the intersection-centric tile may be subdivided into smaller tiles, and navigation control lines may be detected from each of the smaller tiles and aggregated to capture the navigation control lines located at the intersection. In some embodiments, crosswalk lines in the same crosswalk may be identified and paired to form corresponding polygons. As such, detected navigation control lines, detected regions bounded by detected navigation control lines, and/or corresponding class labels may be labeled on the (e.g., global LiDAR) map.

As such, the detected navigation control lines (e.g., traffic signal road lines) may be used to label a global LiDAR map, and the global LiDAR map may be distributed or otherwise accessed by any number of ego-machines to facilitate navigation, localization, and/or other uses. The present techniques provide a variety of benefits over prior techniques. For example, generating intersection-centered tiles effectively arranges semantically meaningful features into a single input representation, so detecting navigation control lines from intersection-centered tiles focuses the DNN on more relevant information than prior techniques, resulting in improved detection accuracy and precision over prior techniques. In addition, various embodiments save a great deal of computational effort. For example, using projected LiDAR data obviates the need for computationally expensive backpropagations of image data. In another example, detecting navigation control lines from intersection-centered tiles should serve to detect complete line segments from most intersections, obviating the need in conventional techniques to connect disjoint pieces of the same line segment detected from different tiles. Additionally, detecting navigation control lines from projected LiDAR data reduces and even eliminates many distortions and occlusions depicted in projected camera images, resulting in a more accurate representation of the surrounding environment, and therefore, more accurate line detections and more accurate downstream uses. As such, a labeled map generated using the present or similar techniques may improve the manner in which an autonomous or semi-autonomous vehicle or machine navigates and localizes in a physical environment, especially at intersections and traffic signal-controlled areas.

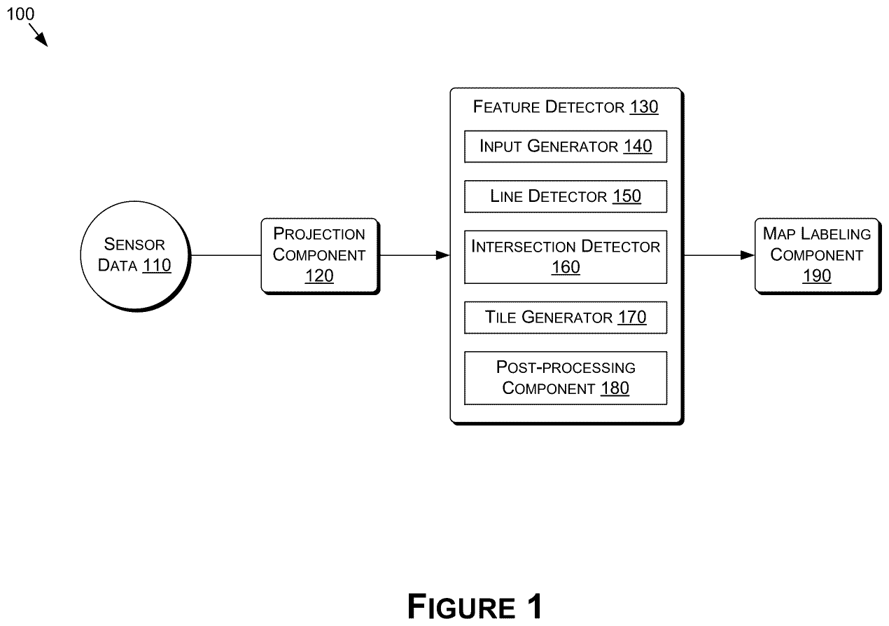

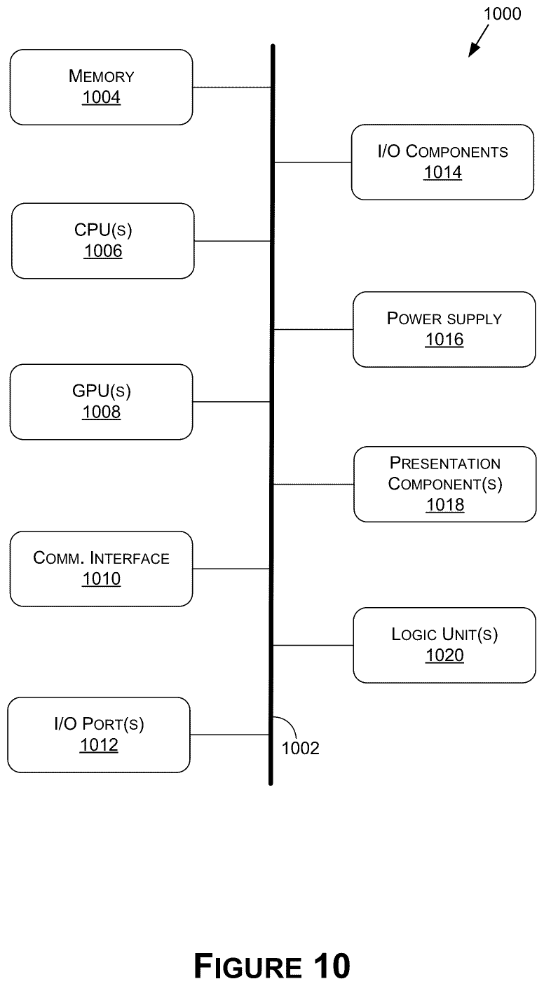

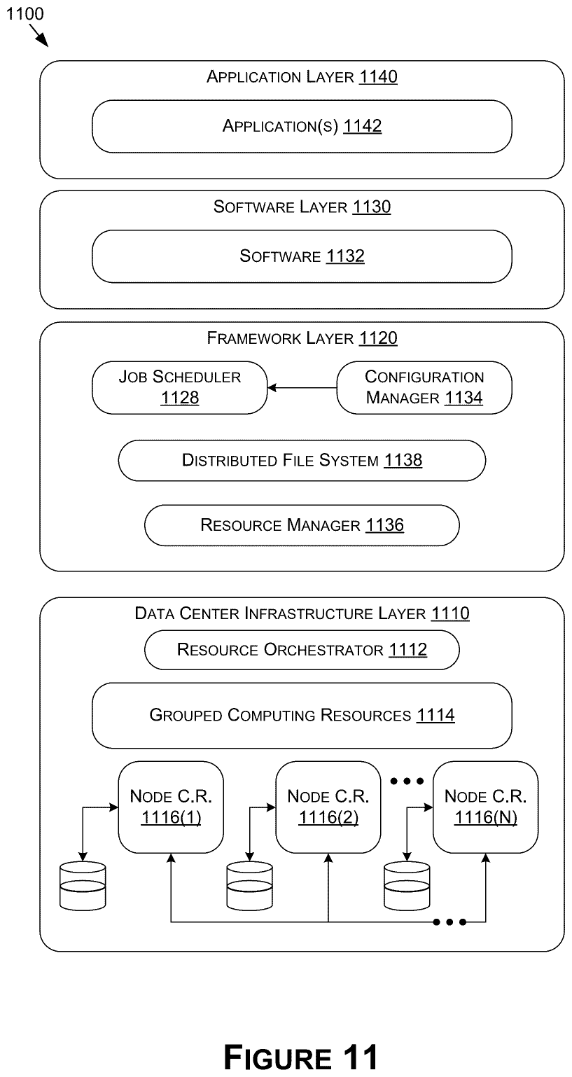

With reference to FIG. 1, FIG. 1 is an example map generation pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 900 of FIGS. 9A-9D, example computing device 1000 of FIG. 10, and/or example data center 1100 of FIG. 11.

The map generation pipeline 100 may generate a map using data collected by one or more fleet vehicles (e.g., autonomous, semi-autonomous, non-autonomous vehicles) or other ego-machines that navigate roads, driving surfaces, and/or other environments. For example, sensor data 110 (which may include LiDAR intensity data in some embodiments) may be collected using one or more ego-machines (e.g., a fleet of data collection vehicles), sent to the map generation pipeline 100 (e.g., which may be hosted at a remote location such as a datacenter), and a projection component 120 may project the sensor data 110 into a 2D representation of the ground or other surface. In some examples, a feature detector 130 (which may be referred to as navigation control line detector 130 when deployed for line detection) may detect navigation control lines (e.g., traffic signal road lines or other road markings or lines on the road that represent traffic signals, such as crosswalk lines, stop lines, or yield lines) within the 2D representation of the ground or other surface. Taking an example embodiment in which the 2D representation of the ground is a LiDAR map representing some geographic region, an input generator 140 may divide the LiDAR map into tiles, and a line detector 150 may detect navigation control lines from the individual tiles. Continuing the example, an intersection detector 160 may use the detected navigation control lines to detect intersections based on the geometry and proximity of the detected navigation control lines. As such, a tile generator 170 may generate new tiles centered around the detected intersections and trigger the line detector 150 to detect navigation control lines from each resulting intersection centered tile. A post-processing component 180 may aggregate, de-duplicate, and/or merge detected navigation control lines, and a map labeling component 190 may use these detected navigation control lines to label the map. As such, the labeled map may be distributed and used by an autonomous or semi-autonomous vehicle (e.g., the example autonomous or semi-autonomous vehicle or machine 900) or other ego-machine to aid in navigating a physical environment, for example, allowing the vehicle to accurately interpret and respond to traffic signals represented in the map, navigate intersections safely, adhere to traffic rules, and/or assist the vehicle in precisely determining its position and orientation within the road network or other navigable surface or environment, especially at intersections and/or traffic signal-controlled areas.

In the example illustrated in FIG. 1, the sensor data 110 may be collected using one or more fleet vehicles (e.g., ego-machines). In some examples, sensor data 110 may comprise LiDAR data collected using any number of LiDAR sensors and/or any number of ego-machines. However, this is just an example, and other types of sensor data may additionally or alternatively be used (e.g., data from RADAR sensors, ultrasonic sensors, inertial measurement units, GPS, GNSS or other positioning sensors, thermal sensors, etc.). For example, LiDAR intensity data may be projected onto a 2D surface and collected by one or more ego-machines. In at least some examples, this projection may be done by one or more ego-machines, and a representation of the projected sensor data may be sent to the map generation pipeline 100 (e.g., over any suitable network). Additionally or alternatively, some other representation of the sensor data may be sent to the map generation pipeline 100, and the projection component 120 may operate at a remote location (e.g., a data center, such as the data center 1100, hosting the map generation pipeline 100). In some embodiments, the sensor data 110 may be received by the map generation pipeline 100 as a point cloud (e.g., a list of measured 3D points and corresponding reflection characteristics), a projected representation, and/or some other representation.

The projection component 120 may project the LiDAR or other sensor data (e.g., detected 3D points) from a 3D coordinate system (e.g., whether a global coordinate system like a world map, or a local coordinate system like a vehicle-centric coordinate system) into a particular 2D view (e.g., a 2D map). For example, the projection component 120 may project into a 2D representation of a surface in the environment (e.g., a top-down view of the ground). In some embodiments, the projection component 120 may convert sensor data 110 into pixels of a projection image, and the pixels may be assigned values such as greyscale or color values that represent a corresponding measured value (e.g., LiDAR intensity) of the point that was projected onto each pixel. By projecting multiple observations (e.g., LiDAR spins) of the surface into the 2D representation, the 2D representation of the surface may represent the projected sensor data as a global (e.g., LiDAR) map (e.g., a top-down view of the ground), which may have any number of channels storing any corresponding measurement (e.g., whether derived from LiDAR and/or other types of sensor data).

As such, in some embodiments, the projection component 120 may use the sensor data 110 (e.g., representing some geographic region) to construct a map of the region. In some examples, the feature detector 130 may detect navigation control lines within the 2D representation of the ground (e.g., the global LiDAR map representing) of some geographic region. For example, the feature detector 130 may detect navigation control lines within the (e.g., global LiDAR map) map constructed by the projection component 120.

The feature detector 130 may subdivide the (e.g., global LiDAR) map into (e.g., fixed-size) tiles, use a deep neural network (DNN) to detect and classify navigation control lines (e.g., traffic signal road lines, such as crosswalk lines, stop lines, road boundary lines, bike lane lines, yield lines, painted signs or signals, etc.) and/or other features in each tile, cluster detected navigation control lines to infer the locations of intersections in the map, rerun navigation control line detection on intersection-centered tiles, and/or apply de-duplication to remove any duplicates of detected navigation control lines (e.g., crosswalk lines). As such, in order to detect, classify, and label navigation control lines within the map constructed by projection component 120, the feature detector 130 may use the input generator 140, the line detector 150, the intersection detector 160, the tile generator 170, and/or the post-processing component 180.

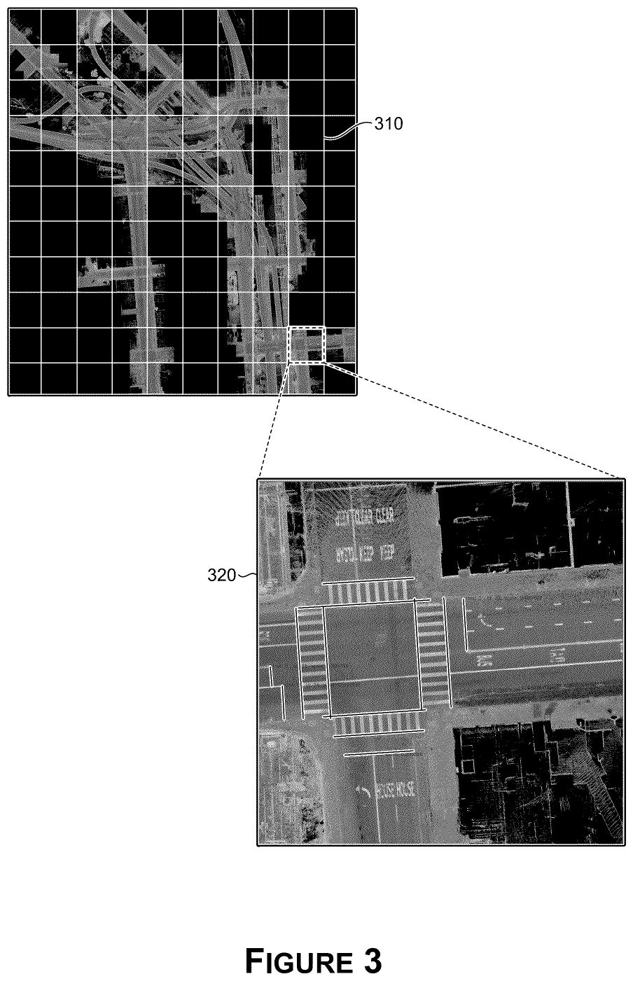

The input generator 140 may subdivide the (e.g., global LiDAR) map into any suitable (e.g., fixed-size) grid cells or tiles to facilitate navigation control line detection. In some examples, these tiles may be non-overlapping or overlapping with adjacent tiles. Whether the tiles are overlapping or non-overlapping may be configurable (e.g., to make the tiles overlapping instead of non-overlapping and vice versa). In some embodiments, the tiles may be fixed in size to facilitate running a single DNN (e.g., or a single DNN architecture) to detect navigation control line features within each tile. FIG. 3 illustrates an example LiDAR map divided into tiles, in accordance with some embodiments of the present disclosure. In this example, the 2D representation of some geographic region (e.g., the global LiDAR map) may be subdivided into (e.g., fixed-size) tiles to form a grid 310, and each tile may be applied to a DNN to detect and classify navigation control lines within the tile (e.g., tile 320).

Returning to FIG. 1, in some embodiments, the line detector 150 may be implemented using neural network(s) such as a DNN or a convolutional neural network (CNN), but this is not intended to be limiting. For example, and without limitation, the line detector 150 may include any type of a number of different networks or machine learning models, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, transformer, recurrent, perceptrons, Long/Short Term Memory (LSTM), large language model (LLM), Hopfield, Boltzmann, deep belief, de-convolutional, generative adversarial, liquid state machine, etc.), and/or other types of machine learning models.

As such, the line detector 150 may use a machine learning model, such as a DNN, to detect and classify navigation control lines. In some implementations, any known line detection technique may be applied to the individual tiles to detect and classify any navigation control lines present in each tile. In some embodiments, a DNN (e.g., LinE segment Transformers (LETR), Tile Net V2, or any model that has the capabilities to detect lines and/or generate a list or other representation of detected polylines) may be used to detect one or more classes of navigation control lines (e.g., line segments or polylines) from each tile of the (e.g., LiDAR) map. Note that depending on what information was encoded into the map, each tile may include any number of channels of corresponding data. In an example embodiment, the output of the DNN may represent several objects, where each object encodes, represents, or otherwise identifies two points or pixels within a tile (e.g., two endpoints P1 and P2, forming a detected line segment), a classification label (e.g., a class denoting that the object does not correspond to a detected line; a supported class of a detected navigation control line, such as crosswalk lines, stop lines, yield lines; an indication that one of a plurality of supported classes was detected; etc.), and a corresponding confidence. In some implementations, the output of the DNN may be a fixed number of objects (e.g., 100), each having two points (e.g., pixels of within the tile representing corresponding end points), but it may be possible that all of the objects may not fall under a supported class of a detected navigation control line (e.g., crosswalk lines, stop lines, yield lines). Therefore, in at least some embodiments, a threshold confidence may be applied to decode the DNN output (e.g., and identify the detected navigation control lines).

Accordingly, the line detector 150 may decode the DNN output and generate a list of detected lines and corresponding class labels (e.g., labeling the navigation control lines as crosswalk lines, stop lines, or yield lines). In some embodiments, the line detector 150 may apply a designated threshold confidence to the DNN output to identify the detected navigation control lines. In some embodiments, each object (e.g., each set of two points or pixels) is assigned a score, and a threshold confidence may be used to separate all of the objects in the DNN output based on that score. For example, a score may be associated with each classification label (e.g., a class denoting that the object does not correspond to a detected line; a supported class of a detected navigation control line, such as crosswalk lines, stop lines, yield lines; an indication that one of a plurality of supported classes was detected; etc.) and a threshold confidence may be applied to filter out the scores that do not correspond to detected navigation control lines. Thus, in that example, the line detector 150 may separate all of the objects that are not detected navigation control lines from all of the objects that are navigation control lines (e.g., crosswalk lines, stop lines, yield lines, etc.). Note this is just meant as an example, and any suitable line detection technique may be used to detect lines of one or more designated classes.

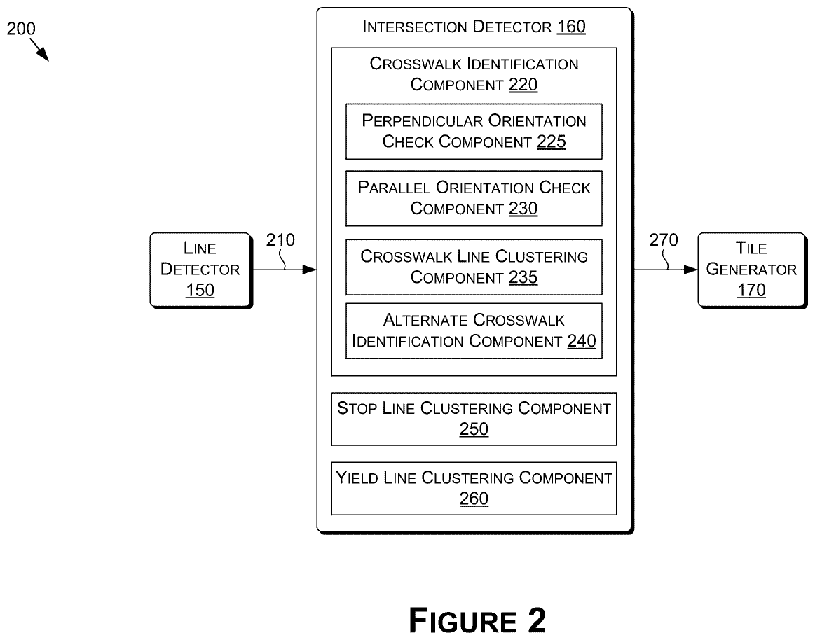

The intersection detector 160 may cluster detected navigation control lines to infer the locations of intersections within each tile of the (e.g., LiDAR) map. Referring now to FIG. 2, FIG. 2 is a diagram illustrating an example intersection detector 160, in accordance with some embodiments of the present disclosure. In some examples, the intersection detector 160 may receive a list of detected navigation control lines from the line detector 150, and this list is represented by arrow 210. In some embodiments, the intersection detector 160 may iterate through the detected crosswalk lines and search for other detected crosswalk lines that are nearby (e.g., within one or more threshold distances of) other crosswalk lines. For each pair of detected crosswalk lines within a threshold distance, for example, the intersection detector 160 may label and group the pairs of crosswalk lines as part of an inferred intersection. Additionally or alternatively, according to some embodiments, the intersection detector 160 may iterate through these inferred intersections (e.g., detected intersections) and iterate through one or more other classes of detected navigation control lines (e.g., stop lines, yield lines, etc.) to label and group into the inferred intersection the other nearby navigation control lines within the same intersection.

In the embodiment illustrated in FIG. 2, the intersection detector 160 includes a crosswalk identification component 220, a perpendicular orientation check component 225, a parallel orientation check component 230, a crosswalk line clustering component 230, an alternative crosswalk identification component 240, a stop line clustering component 250, and a yield line clustering component 260.

The crosswalk identification component 220 may iterate through the list of detected navigation control lines 210 (whether on a per-tile and/or aggregate basis), iterate through detected crosswalk lines, search for other detected crosswalk lines within a threshold distance, and cluster adjacent and/or nearby crosswalk lines. For each pair of detected crosswalk lines within a threshold distance, for example, the intersection detector 160 may determine whether the crosswalk lines are substantially perpendicular and substantially parallel to one another, and, if so, intersection detector 160 may label and group the pairs of crosswalk lines as part of an inferred intersection. In some embodiments, intersection detector 160 may adjust its threshold angles to detect crosswalk lines at different types of intersections (e.g., 3-way intersections, 4-way intersections, 5-way intersections, etc.) in different iterations. In the embodiment illustrated in FIG. 2, the crosswalk identification component 220 includes the perpendicular orientation check component 225, the parallel orientation check component 230, the crosswalk line clustering component 230, and the alternative crosswalk identification component 240.

The perpendicular orientation check component 225 and the parallel orientation check component 230 may be part of an overall orientation check which determines whether the relative orientation of detected navigation control lines corresponds to a predetermined geometric pattern represented in an intersection. In at least some implementations, the perpendicular orientation check 225 may determine whether the crosswalk lines attach (e.g., meet at an angle within some threshold range) and/or are within some threshold distance (e.g., a foot or two) of one another, which may be used as an indication that those crosswalk lines are part of the same crosswalk. For example, the perpendicular orientation check 225 may determine that a pair of detected crosswalk lines are substantially perpendicular within some designated angular threshold. In at least some such examples, the crosswalk clustering component 235 may label the pair as part of an (e.g., inferred) intersection. In some examples, crosswalks typically have two parallel lines, and intersections may include multiple crosswalks. In at least some embodiments, each pair of crosswalk lines that satisfies the orientation check (e.g., both the perpendicular orientation check and the parallel orientation check), may be labeled as part of (e.g., clustered into) a detected intersection by the crosswalk clustering component 235, and/or used to trigger the parallel orientation check 230 to test the pair for parallelism.

Furthermore, in at least some implementations, the parallel orientation check 230 may determine when a pair of crosswalk lines are substantially coplanar (e.g., do not intersect) within a threshold distance (e.g., a few feet) of one another, which may be used as an indication that those crosswalk lines are part of the same crosswalk. Additionally or alternatively, in at least some examples, the parallel orientation check 230 may run an overlap check to determine whether one crosswalk line (e.g., from a pair of crosswalk lines) projects onto substantially all of the length of the other crosswalk line within some threshold (e.g., a few feet). In some embodiments, when the parallel orientation check 230 determines that a pair of crosswalk lines are substantially parallel and/or project substantially onto one another, the parallel orientation check 230 may determine that those parallel crosswalk lines are part of the same crosswalk. In some implementations, the orientation check component 225 (e.g., both the perpendicular orientation check and the parallel orientation check) and the parallel orientation check component 230 may be run in any order. For example, each pair of crosswalk lines that satisfies both of the orientation checks (e.g. or one of the checks in some embodiments) may be labeled as part of (e.g., clustered into) a detected intersection by the crosswalk clustering component 235. As such, in at least some examples, the crosswalk clustering component 235 may label the pair as part of an (e.g., inferred) intersection.

Depending on the type of intersection, the alternative crosswalk identification component 240 may adjust the threshold angles to detect crosswalk lines at different types of intersections. For example, the threshold angles for a perpendicular orientation check may be adjusted depending on whether the inferred intersection is a 3-way intersection, 4-way intersection, 5-way intersection, or any other type of intersection. In at least some embodiments, regardless of the type of intersection, the alternative crosswalk identification component 240 may adjust the threshold angles so that an orientation check (e.g., both the perpendicular orientation check and the parallel orientation check) and an overlap check (e.g., of the parallel orientation check component 230) may be performed on pairs of detected crosswalk lines in order to detect and cluster the pairs into an (e.g., inferred) intersection (e.g., a detected intersection).

Additionally or alternatively, other navigation control lines may be detected and labeled as part of the detected intersection. For example, the stop line clustering component 250 may iterate through the detected intersections (e.g., for each inferred intersection) and search for detected stop lines within a threshold distance (e.g., from the inferred intersection) to cluster nearby stop lines into a corresponding (e.g., inferred) intersection. In some embodiments, an orientation check (e.g., both the perpendicular orientation check and the parallel orientation check) may be run across detected crosswalk lines in the detected intersection to identify stop lines within a threshold distance from the crosswalk lines. As such, for example, the stop line clustering component 250 may chose a reference line (e.g., one of the detected crosswalk lines of the detected intersection), select a corresponding threshold distance (e.g., based on the type of reference line and how far away stop lines typically appear from that type of line), apply the designated distance threshold to determine whether the stop line is part of the same intersection as the reference line, and/or run an orientation check for stop lines (e.g., a stop line parallel to a reference crosswalk line of the detection intersection, and/or a stop line that is perpendicular to the reference crosswalk line). In some implementations, the stop line clustering component 250 may detect stop lines that satisfy this orientation check and/or distance threshold and cluster these stop lines into the detected intersection.

Additionally or alternatively, in some implementations, the yield line clustering component 260 may iterate through the detected intersections (e.g., for each inferred intersection) and search for detected yield lines within a threshold distance to cluster nearby yield lines into the intersection. For example, the same orientation check (e.g., as used to detect lines within a threshold angular orientation of one another) and/or a corresponding distance threshold (e.g., yield lines within a few feet of crosswalk lines) may be run across detected crosswalk lines in the detected intersection to identify yield lines within a threshold distance from the crosswalk lines. Accordingly, detected yield lines that are within a threshold distance from a reference crosswalk line and that satisfy the orientation check may be clustered into the detected intersection by the yield line clustering component 260.

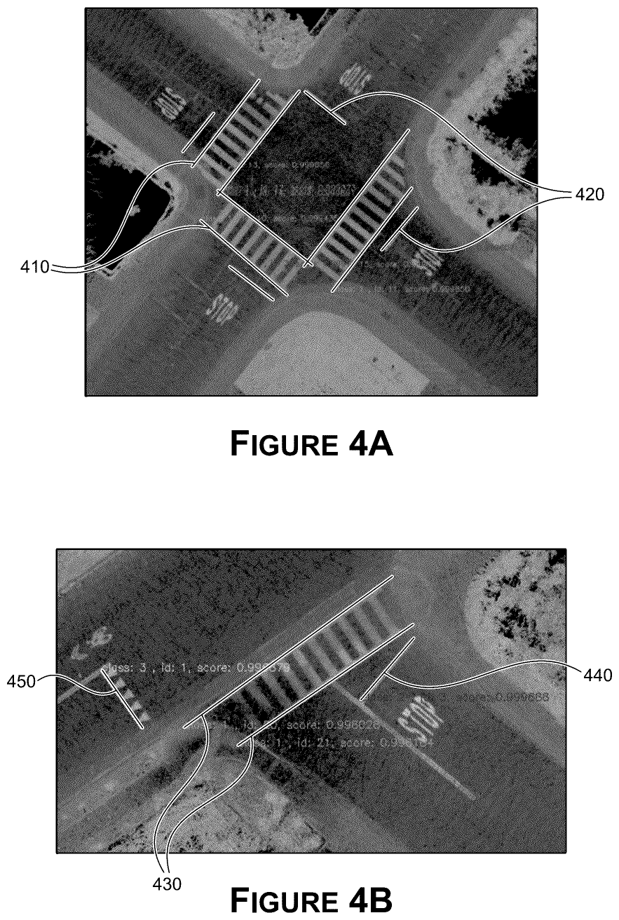

Referring briefly now to FIGS. 4A and 4B, FIGS. FIGS. 4A and 4B illustrate example embodiments of detected navigation control lines determined at alternative crosswalk orientations. Intersections are constructed in different sizes and configurations with varying types and quantities of navigation control lines. For example, FIG. 4A illustrates a four-way intersection in which six crosswalk lines 410 and four stop lines 420 may be detected. In another example, FIG. 4B depicts a three-way intersection in which two crosswalk lines 430, one stop line 440, and one yield lines 450 are detected. As shown in these example embodiments, regardless of the type of intersection (e.g., two-way, three-way, four-way, five-way, etc.) and the number of navigation control lines located at that intersection, the intersection detector 160 may detect navigation control lines that are part of an (e.g., inferred) intersection and cluster those navigation control lines into a detected intersection.

Returning to FIG. 2, each detected intersection may be formed from the detected crosswalk lines (e.g., identified and clustered into the inferred intersection by the crosswalk identification component 230), the detected stop lines (e.g., identified and clustered into the inferred intersection by the stop line clustering component 250), and/or the detected yield lines (identified and clustered into the inferred intersection by the yield line clustering component 260). As such, the intersection detector 160 may detect each intersection (e.g., whether within a tile or across tiles) by inferring intersections based on the detected navigation control lines (e.g., crosswalk lines, stop lines, yield lines, etc.). In at least some embodiments, the tile generator 170 may receive a representation of each detected intersection (e.g., indicated by arrow 270) from the intersection detector 160.

Referring back now to FIG. 1, the tile generator 170 may create a new intersection-centered tile for each detected (e.g., inferred) intersection, and the intersection-centered tile may be centered around the detected intersection. In at least some examples, the tile generator 170 may generate and/or align an intersection-centered (e.g., intersection-centric) tile to correspond with the boundaries of an inferred intersection, which should serve to maximize or increase the number of intersection features that are represented within the intersection-centered tile. In some embodiments, the tile generator 170 may rotate an intersection centered-tile and/or resize (e.g., scale) an intersection-centered tile into larger or smaller tiles (e.g., up to a certain threshold). For example, to facilitate feature detection within an intersection-centered tile, the tile generator 170 may rotate the intersection-centered tile (e.g., either clockwise or counterclockwise) to align more closely with the boundaries of the detected intersection. In some embodiments, if the intersection is larger or smaller than a target resolution for an intersection-centered tile, the tile generator 170 may resize the intersection-centered tile by applying some scaling factor (e.g., 0.8 to 1.2, for example). Additionally or alternatively, if an intersection is (e.g., substantially) larger than some designated threshold resolution for an intersection-centered tile (e.g., a representation of an intersection containing 1500 pixels compared to an intersection-centric tile with a 1000 pixel limit), the tile generator 170 may subdivide the intersection-centered tile into smaller tiles.

The line detector 150 may detect navigation control lines from each intersection-centered tile generated using the tile generator 170 (as described above). As such, once some or all of the tiles are generated, the line detector 150 may rerun navigation control lines detection on each new intersection-centered tile. Therefore, according to some embodiments of the present disclosure, the intersection-centered tile may be applied to the machine learning model of the line detector 150.

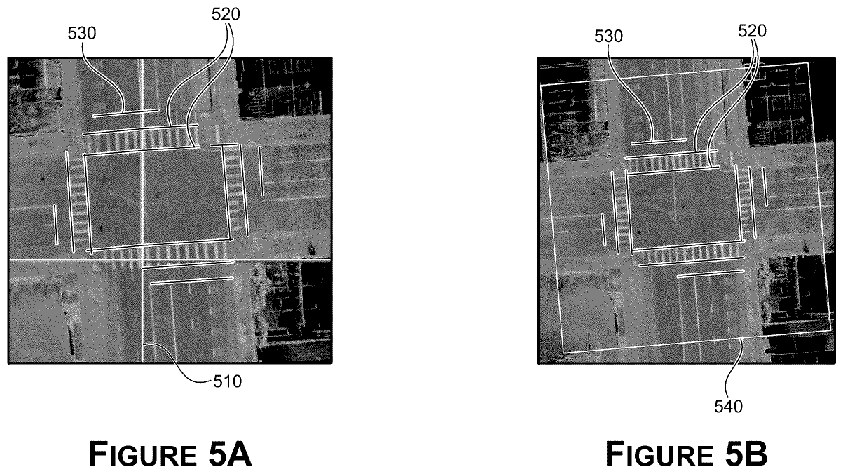

For example, referring now to FIGS. 5A and 5B, FIG. 5B illustrates an example intersection-centered tile 550. In at least some embodiments, the 2D representation represents the ground (e.g., the global LiDAR map) of some geographic region, as illustrated in FIG. 5A. In FIG. 5A, a detected intersection has been inferred and located (e.g., spanning) four tiles separated by the grid 510 (e.g., which may correspond to the example grid illustrated in FIG. 3). Continuing the example, FIG. 5A includes eight crosswalk lines (e.g., 520) and four stop lines (e.g., 530). In at least some examples, the tile generator 170 of FIG. 1 may create the intersection-centered tile 540, as illustrated in FIG. 5B, centered around the detected intersection. As such, the intersection-centered tile 540 may be centered around the detected intersection. In at least some examples the intersection-centered tile 540 may be applied to the line detector 150, which may detect and classify navigation control lines within the intersection-centered tile 540.

Referring back to FIG. 1, the post-processing component 180 may aggregate and/or de-duplicate detected navigation control lines. In some embodiments, local sectors may overlap, which may result in duplicated detected navigation control lines (e.g., such as duplicates of navigation control lines detected by the line generator 150, for example, when the tiles in a grid overlap). In some examples, the post-processing component 180 may search for navigation control lines that are (e.g., substantially) close to one another (e.g., determining the distance between the lines and applying a corresponding distance threshold), and run an overlap check. In some embodiments, the post-processing component 180 (e.g., operating similar to the intersection detector 160) may adjust the threshold distances (e.g., within some number of inches or centimeters) between the duplicated navigation control lines so that an orientation check (e.g., a parallel orientation check) and an overlap check (e.g., of the parallel orientation check component 230) may be performed to detect duplicates of detected navigation control lines. If a pair of navigation control lines substantially overlap more than some threshold (e.g., such as a ninety-nine percent overlap), for example, duplicated lines may be de-duplicated by the post-processing component 180. Additionally or alternatively, crosswalk lines in the same intersection may be identified (e.g., based on an orientation check and being within some threshold distance) and paired by the post-processing component 180 to form corresponding bounding boxes, polygons, or other bonding shapes.

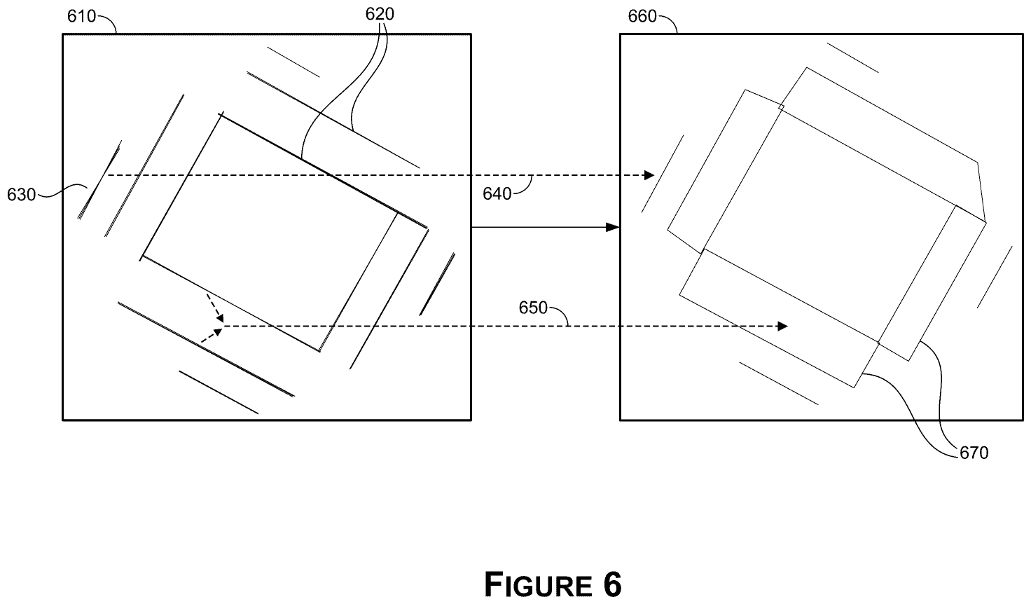

Referring now to FIG. 6, FIG. 6 illustrates an example of de-duplicating detected navigation control lines (e.g., crosswalk lines and stop lines). As illustrated in the example left detected intersection 610 in a labeled map, there are several duplicated crosswalk lines 620 and duplicated stop lines 630 (e.g., depicted as thicker or overlapping lines). As such, the post-processing component 180 may apply de-duplication on detected navigation control lines (e.g., represented by arrow 640). Additionally or alternatively, post-processing component 180, may pair de-duplicated crosswalk lines (e.g., represented by arrow 650) to form polygons 670, as illustrated in the example right detected intersection 660 in a labeled map. In at least some examples, these polygons may be used to label (e.g., and/or update) a map.

Referring back now to FIG. 1, the map-labeling component 190 may use the detected polygons and/or the detected navigation control lines to label or otherwise update the (e.g., global LiDAR) map. For example, the detected navigation control lines from different tiles (e.g., such as called out tile 320 and any other tile from grid 310 of FIG. 3; and/or any intersection-centered tile) may be aggregated and used to label a 2D representation of the ground or other surface (e.g., a LiDAR map). As such, detected navigation control lines, detected regions bounded by detected navigation control lines, and/or corresponding class labels may be labeled by map labeling component 190 on the (e.g., global LiDAR) map.

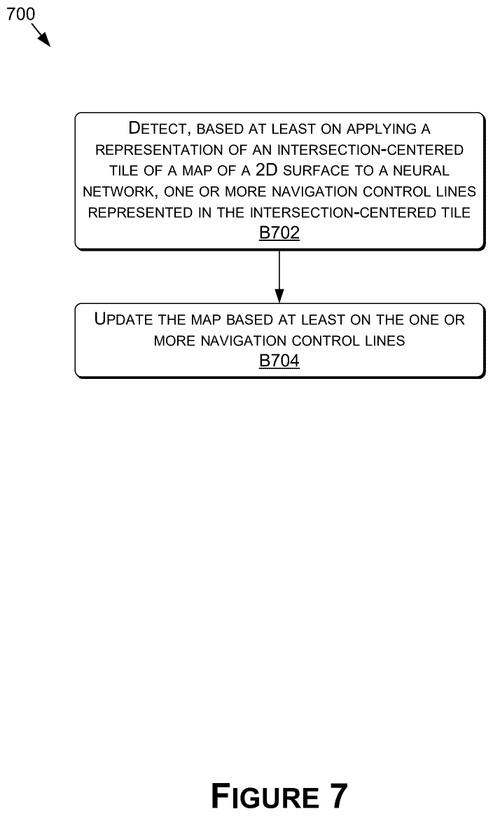

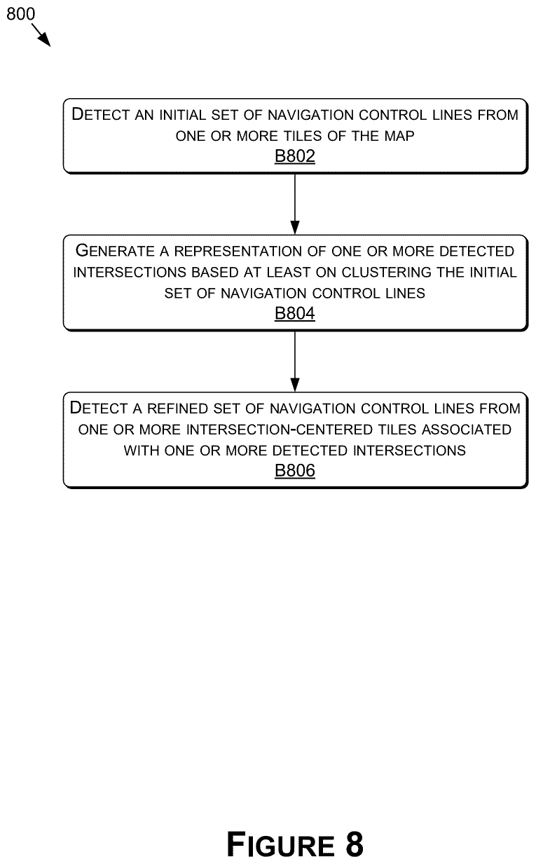

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700 and 800 are described, by way of example, with respect to the map generation pipeline 100 of FIG. 1. However, these methods may additionally or alternatively be executed by any one system, or any combination of systems, including, but not limited to, those described herein.

FIG. 7 is a flow diagram showing a method 700 for updating a map with detected navigation control lines, in accordance with some embodiments of the present disclosure. The method 700, at block B702, includes detecting, based at least on applying a representation of an intersection-centered tile of a map of a 2D surface to a neural network, one or more navigation control lines represented in the intersection-centered tile. For example, the map represents projected LiDAR intensity data, and the line detector 150 may use a neural network (or other machine learning model) to detect and classify lines (e.g., navigation control lines) from intersection-centered tiles of the LiDAR map. Additionally or alternatively, the line detector 150 may decode a machine learning model (e.g., DNN) output and generate a list of detected lines and corresponding class labels (e.g., labeling the navigation control lines as crosswalk lines, stop lines, or yield lines).

The method 700, at block B704, includes updating the map based at least on the one or more navigation control lines. For example, the map labeling component 190 may label a (e.g., global, LiDAR) map with detected navigation control lines, detected regions bounded by detected navigation control lines, and/or corresponding class labels. As such, the map-labeling component 190 may use the detected navigation control lines to update the (e.g., global, LiDAR) map.

FIG. 8 is a flow diagram showing a method 800 for detecting a refined set of navigation control lines, in accordance with some embodiments of the present disclosure. The method 800, at block B802, includes detecting an initial set of navigation control lines from one or more tiles of the map. For example, with respect to the map generation pipeline 100 of FIG. 1, the line detector 150 may use a machine learning model, such as a DNN, to detect and classify navigation control lines within one or more tiles of a LiDAR map.

The method 800, at block B804, includes generating a representation of one or more detected intersections based at least on clustering the initial set of navigation control lines. For example, the tile generator 170 may generate a new intersection-centered tile for each detected (e.g., inferred) intersection, and the intersection-centered tile may be centered around the detected intersection by the tile generator 170. In at least some examples, the tile generator 170 may generate and/or align an intersection-centered tile to correspond with the boundaries of an inferred intersection, which should serve to maximize or increase the number of intersection features that are represented within the intersection-centered tile.

The method 800, at block B806, includes detecting a refined set of navigation control lines from one or more intersection-centered tiles associated with one or more detected intersections. For example, the line detector 150 may detect navigation control lines from each intersection-centered tile generated using the tile generator 170 and aggregate the detected navigation control lines to capture the navigation control lines located at the detected intersection (e.g., a refined set of navigation control lines).

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to allow the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to allow autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), one or more occupant monitoring system (OMS) sensor(s) 901 (e.g., one or more interior cameras), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

Cameras with a field of view that include portions of the interior environment within the cabin of the vehicle 900 (e.g., one or more OMS sensor(s) 901) may be used as part of an occupant monitoring system (OMS) such as, but not limited to, a driver monitoring system (DMS). For example, OMS sensors (e.g., the OMS sensor(s) 901) may be used (e.g., by the controller(s) 936) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation allowing any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 904 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LiDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 916 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to allow communication with peripherals, audio codecs, power management, and/or other devices. The SoC(s) 904 may be used to process data from cameras (e.g., connected over Gigabit Multimedia Serial Link and Ethernet), sensors (e.g., LiDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to allow wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated using the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LiDAR sensor(s) 964. The LiDAR sensor(s) 964 may be used for object and pedestrian detection, emergency braking, collision avoidance, and/or other functions. The LiDAR sensor(s) 964 may be functional safety level ASIL B. In some examples, the vehicle 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900 m, with an accuracy of 2 cm-3 cm, and with support for a 900 Mbps Ethernet connection, for example. In some examples, one or more non-protruding LiDAR sensors 964 may be used. In such examples, the LiDAR sensor(s) 964 may be implemented as a small device that may be embedded into the front, rear, sides, and/or corners of the vehicle 900. The LiDAR sensor(s) 964, in such examples, may provide up to a 120-degree horizontal and 35-degree vertical field-of-view, with a 200 m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may allow the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LiDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. As such, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(D) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated using a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

In an example implementation, one or more processors comprise processing circuitry to: detect, based at least on applying a representation of an intersection-centered tile of a LiDAR map of a two-dimensional (2D) surface to a neural network, one or more navigation control lines represented in the intersection-centered tile; and update the LiDAR map based at least on the one or more navigation control lines.

In any combination of any of the elements of any of the foregoing implementations of the one or more processors, the 2D surface represents a ground surface, and the processing circuitry is further to generate the LiDAR map based at least on projecting LiDAR intensity data collected using one or more ego-machines onto the 2D surface.

In any combination of any of the elements of any of the foregoing implementations of the one or more processors, the processing circuitry is further to generate the intersection-centered tile around an inferred intersection detected based at least on an initial set of navigation control lines detected from one or more tiles of the LiDAR map. In some embodiments, the processing circuitry is further to generate the intersection-centered tile around an inferred intersection detected based at least on searching an initial set of navigation control lines detected from the LiDAR map for detected crosswalk lines that form a detected crosswalk.

In any combination of any of the elements of any of the foregoing implementations of the one or more processors, the processing circuitry is further to generate the intersection-centered tile around an inferred intersection detected based at least on searching an initial set of navigation control lines detected from the LiDAR map for detected lines that form different delineated regions in a common intersection.

In any combination of any of the elements of any of the foregoing implementations of the one or more processors, the processing circuitry is further to generate the intersection-centered tile around an inferred intersection detected based at least on clustering one or more detected lines into the inferred intersection.

In any combination of any of the elements of any of the foregoing implementations of the one or more processors, the processing circuitry is further to: detect an initial set of navigation control lines from one or more tiles of the LiDAR map; generate a representation of one or more detected intersections based at least on clustering the initial set of navigation control lines; and detect a refined set of navigation control lines from one or more intersection-centered tiles associated with one or more detected intersections.

In any combination of any of the elements of any of the foregoing implementations of the one or more processors, the processing circuitry is further to: detect an initial set of navigation control lines from one or more tiles of the LiDAR map; and detect one or more intersections based at least on geometry and proximity of the initial set of navigation control lines.

In any combination of any of the elements of any of the foregoing implementations of the one or more processors, the processing circuitry is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system for generating synthetic data; a system for generating synthetic data using AI; a system incorporating one or more virtual machines (VMs); a system implemented at least partially in a data center; or a system implemented at least partially using cloud computing resources.

In an example implementation, a system comprises one or more processors to detect, based at least on processing a representation of an intersection-centered tile of a map of a two-dimensional (2D) surface using a neural network, one or more lines represented in the intersection-centered tile.

In any combination of any of the elements of any of the foregoing implementations of the system, the 2D surface represents a ground surface, and the one or more processors are further to generate the map based at least on projecting intensity data collected using one or more ego-machines onto the 2D surface.

In any combination of any of the elements of any of the foregoing implementations of the system, the one or more processors are further to generate the intersection-centered tile around an inferred intersection detected based at least on an initial set of lines detected from one or more tiles of the map.

In any combination of any of the elements of any of the foregoing implementations of the system, the one or more processors are further to generate the intersection-centered tile around an inferred intersection detected based at least on searching an initial set of lines detected from the map for detected crosswalk lines that form a detected crosswalk.

In any combination of any of the elements of any of the foregoing implementations of the system, the one or more processors are further to generate the intersection-centered tile around an inferred intersection detected based at least on searching an initial set of lines detected from the map for detected lines that form different delineated regions in a common intersection.

In any combination of any of the elements of any of the foregoing implementations of the system, the one or more processors are further to generate the intersection-centered tile around an inferred intersection detected based at least on clustering one or more detected lines into the inferred intersection.

In any combination of any of the elements of any of the foregoing implementations of the system, the one or more processors are further to: detect an initial set of lines from one or more tiles of the map; generate a representation of one or more detected intersections based at least on clustering the initial set of lines; and detect a refined set of lines from one or more intersection-centered tiles associated with one or more detected intersections.

In any combination of any of the elements of any of the foregoing implementations of the system, the one or more processors are further to: detect an initial set of lines from one or more tiles of the map; and detect one or more intersections based at least on geometry and proximity of the initial set of lines.

In any combination of any of the elements of any of the foregoing implementations of the system, the system is comprised in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system for generating synthetic data; a system for generating synthetic data using AI; a system incorporating one or more virtual machines (VMs); a system implemented at least partially in a data center; or a system implemented at least partially using cloud computing resources.

In an example implementation, a method comprises: detecting, based at least on processing a representation of a tile of a map centered around a detected intersection using a neural network, one or more lines represented in the tile; and updating the map based at least on the one or more lines

In any combination of any of the elements of any of the foregoing implementations of the method, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. One or more processors comprising processing circuitry to:
detect, based at least on applying a representation of an intersection-centered tile of a LiDAR map of a two-dimensional (2D) surface to a neural network, one or more navigation control lines represented in the intersection-centered tile; and
update the LiDAR map based at least on the one or more navigation control lines.

2. The one or more processors of claim 1, wherein the 2D surface represents a ground surface, and wherein the processing circuitry is further to generate the LiDAR map based at least on projecting LiDAR intensity data collected using one or more ego-machines onto the 2D surface.

3. The one or more processors of claim 1, wherein the processing circuitry is further to generate the intersection-centered tile around an inferred intersection detected based at least on an initial set of navigation control lines detected from one or more tiles of the LiDAR map.

4. The one or more processors of claim 1, wherein the processing circuitry is further to generate the intersection-centered tile around an inferred intersection detected based at least on searching an initial set of navigation control lines detected from the LiDAR map for detected crosswalk lines that form a detected crosswalk.

5. The one or more processors of claim 1, wherein the processing circuitry is further to generate the intersection-centered tile around an inferred intersection detected based at least on searching an initial set of navigation control lines detected from the LiDAR map for detected lines that form different delineated regions in a common intersection.

6. The one or more processors of claim 1, wherein the processing circuitry is further to generate the intersection-centered tile around an inferred intersection detected based at least on clustering one or more detected lines into the inferred intersection.

7. The one or more processors of claim 1, wherein the processing circuitry is further to:
detect an initial set of navigation control lines from one or more tiles of the LiDAR map;
generate a representation of one or more detected intersections based at least on clustering the initial set of navigation control lines; and
detect a refined set of navigation control lines from one or more intersection-centered tiles associated with one or more detected intersections.

8. The one or more processors of claim 1, wherein the processing circuitry is further to:
detect an initial set of navigation control lines from one or more tiles of the LiDAR map; and
detect one or more intersections based at least on geometry and proximity of the initial set of navigation control lines.

9. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

10. A system comprising one or more processors to detect, based at least on processing a representation of an intersection-centered tile of a map of a two-dimensional (2D) surface using a neural network, one or more lines represented in the intersection-centered tile.

11. The system of claim 10, wherein the 2D surface represents a ground surface, and wherein the one or more processors are further to generate the map based at least on projecting intensity data collected using one or more ego-machines onto the 2D surface.

12. The system of claim 10, wherein the one or more processors are further to generate the intersection-centered tile around an inferred intersection detected based at least on an initial set of lines detected from one or more tiles of the map.

13. The system of claim 10, wherein the one or more processors are further to generate the intersection-centered tile around an inferred intersection detected based at least on searching an initial set of lines detected from the map for detected crosswalk lines that form a detected crosswalk.

14. The system of claim 10, wherein the one or more processors are further to generate the intersection-centered tile around an inferred intersection detected based at least on searching an initial set of lines detected from the map for detected lines that form different delineated regions in a common intersection.

15. The system of claim 10, wherein the one or more processors are further to generate the intersection-centered tile around an inferred intersection detected based at least on clustering one or more detected lines into the inferred intersection.

16. The system of claim 10, wherein the one or more processors are further to:
detect an initial set of lines from one or more tiles of the map;
generate a representation of one or more detected intersections based at least on clustering the initial set of lines; and
detect a refined set of lines from one or more intersection-centered tiles associated with one or more detected intersections.

17. The system of claim 10, wherein the one or more processors are further to:
detect an initial set of lines from one or more tiles of the map; and
detect one or more intersections based at least on geometry and proximity of the initial set of lines.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
detecting, based at least on processing a representation of a tile of a map centered around a detected intersection using a neural network, one or more lines represented in the tile; and
updating the map based at least on the one or more lines.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.
